(19) United States
(12) Patent Application Publication
(10) Pub. No.: US 2022/0058231 A1
(43) Pub. Date: Feb. 24, 2022

(54) Method, Apparatus and System to Keep Out Users From Inappropriate Content During Electronic Communication

(71) Applicant: Anil Nadiminti, Princeton, NJ (US)

(72) Inventor: Anil Nadiminti, Princeton, NJ (US)

(21) Appl. No.: 17/408,863

(22) Filed: Aug. 23, 2021

Related U.S. Application Data
(60) Provisional application No. 63/069,593, filed on Aug. 24, 2020.

(51) Int. Cl. G06F 16/9535; G06F 16/9035; G06F 16/908; G06K 9/62

(52) U.S. Cl. CPC G06F 16/9535; G06K 9/6264; G06F 16/908; G06F 16/9035

(57) ABSTRACT

A method and system of filtering content of an electronic communication is disclosed. The method evaluates the content, transmitted during the electronic communication. Further, the method computes the risk score associated with the content, filters out the content if the risk score crosses a threshold and makes decision based on the risk score.

### RELATED APPLICATION

This utility patent application claims the benefit under 35 United States Code § 119(e) of U.S. Provisional Patent Application No. 63/069,593 filed on Aug. 24, 2020, which is hereby incorporated by reference in its entirety.

### TECHNICAL FIELD

The present invention generally relates to communication software.

More specifically, the present invention relates to a software system for identifying classifying unwanted content to ensure the safety of users' electronic communication.

### BACKGROUND

A system that ensures the safety of electronic communication by detecting unwanted content is in demand.

With advances in technology, the Internet has established itself as one of the main building blocks of the global information infrastructure. The vast majority of content transferred via the Internet is for highly productive business or private usage, but like any other communication technology, the Internet can be used to transmit harmful or illegal content or can be misused as a vehicle for criminal activities.

There has been a major shift toward electronic/online communication, with workplaces, educational institutions, religious services, student activities, learning activities, political rallies, and the like having moved to online modes of communication. The content of such communication, whether video, audio, or text, such as in chat rooms and online forums, needs to be evaluated for inappropriate content, prior to being transmitted to users engaged in conversation.

In this era, when children are engaging in Internet-based or electronic education teaching methods, it is important to provide a platform or tool that filters out content such as pornography, nudity, and display of criminal behavior, gore, murder, extreme violence, dangerous weapons, and the like, to prevent them from accidentally being exposed to such communications as part of the electronic media disseminated to them via electronic teaching methods or engaging in communication.

Autistic people or people who might have a mental illness may not be able to tolerate certain levels of violence, and such a system can be of service to them. Children, likewise, should be prevented from being exposed to such communication, and people in still other age categories may not wish to be exposed to objectionable content, whether in the workplaces or out of personal preference or religious objection.

Although the benefits of the Internet may far outweigh its negative aspects, the latter are becoming increasingly pressing issues of public, political, commercial and legal interest. Accordingly, there is a need to develop a system to solve these problems.

The present invention is intended to address problems associated with and/or otherwise improve on conventional systems through an innovative filtering system that is designed to provide a convenient means of filtering content transmitted during the electronic communication while incorporating other problem-solving features.

### SUMMARY

In one embodiment, a method of filtering content of an electronic communication is disclosed. The method evaluates the content, transmitted during the electronic communication. Further, the method computes the risk score associated with the content, filters out the content if the risk score crosses a threshold and makes decision based on the risk score.

In another embodiment, a system of filtering content of an electronic communication is disclosed. The system evaluates the content, transmitted during the electronic communication. Further, the system computes the risk score associated with the content, filters out the content if the risk score crosses a threshold and makes decision based on the risk score.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles. All illustrations of the drawings are for the purpose of describing selected versions of the present invention and are not intended to limit the scope of the present invention.

FIG. 1 is an illustration of one embodiment of the present invention.

FIG. 2 is an illustration of one embodiment of the present invention in a network environment.

FIG. 3 is an illustration of one embodiment of the evaluation step of the present invention.

FIG. 4 is an illustration of one embodiment of the decision step of the present invention.

### DETAILED DESCRIPTION

Exemplary embodiments are described with reference to the accompanying drawings. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

The present invention (“Apparatus to Keep Out Users From Inappropriate Content During Electronic Communication”) provides an intelligent machine or system that can analyze video, text, audio, or other visual signals sent by electronic communication, inspecting them for unsafe and inappropriate content. The present invention automatically detects and isolates unsafe content to keep its users safe from inappropriate content.

The present invention can also be used as a wrapper filter layered atop existing communications platforms.

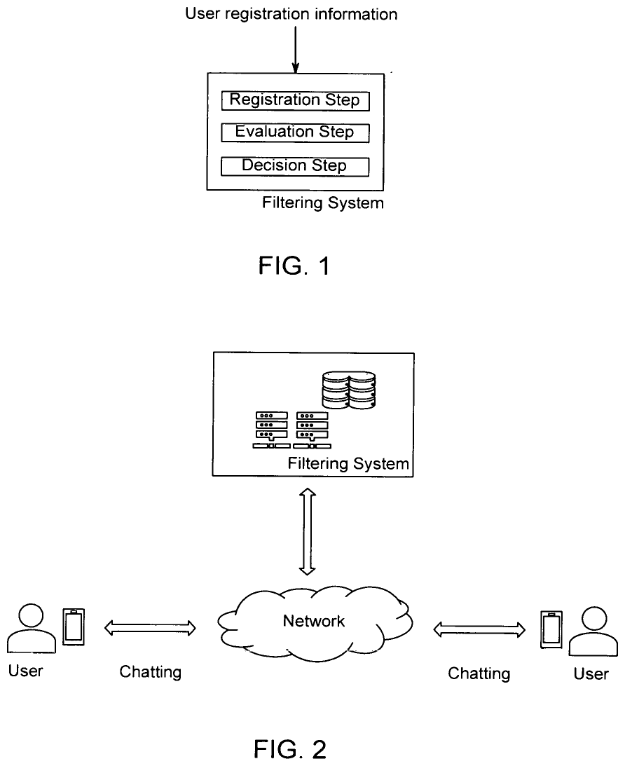

As FIGS. 1-2 show, the present invention provides a filtering system that comprises a plurality of processors and a plurality of memories, the latter of which contain instructions that when executed by a processor trigger a registration step, an evaluation step, and a decision step. The instructions may include routines, programs, objects, data structures, and the like.

The filtering system can be implemented in a network environment, which can comprise one or more servers or one or more data stores and software running on the servers. Software may include Artificial Intelligence/Machine Learning (AI/ML) algorithm that is continuously improving the filtering/evaluation mechanism.

In some embodiments, the filtering system of the present invention can be loaded on a user's computing device, which may be communicatively connected to a network. In other embodiments, the filtering system may be deployed on a computing device such that the filtering system may be configured as a cloud system.

Registration Step

The registration step may include a registration process that is configured to retrieve registration information from users.

In one embodiment, the registration process may include an online registration display (e.g., registration form) that allows a user (e.g., a participant in audio, video, or text chat, screenshare or other electronic communication over the Internet or any other communication medium) to input user registration information such as company information, personal information, and communication products or services that the user intends to use.

In some embodiments, the online registration display may be one or more webpages or user interface that include a list of communication applications, displayed so that the user may select them by following links or clicking on buttons.

In some embodiments, the user registration information may be stored in a database storage or blockchain that can be included in the user computing device or on any server communicatively connected to the user device.

The filtering system of the present invention may allow communication similar to other audio/video communication methods, such as that involving meetings, joining, sharing, screenshare, presentations, text chat, audio chat, video chat, and chat via avatars. Such communication is typically over the Internet but may also be via any other network communication medium, whether satellite Internet, 5G, WAN, LAN, Bluetooth, or the like.

In some embodiments, communications may be optionally encrypted from end to end to protect them from eavesdropping.

All the content involved in communication between users can be analyzed in the filtering system so that an algorithm provided in the evaluation step may score the content to identify a risk score for unsafe content before transmitting any content to users.

Evaluation Step

The evaluation step can be configured to provide content evaluation and an associated risk score to filter out unwanted content.

In some embodiments, the evaluation step may include processing of audio, video, images, text received from operation of detection devices such as cameras and sensors of various types to perform various detection tasks, including object detection, scene detection, and activity detection.

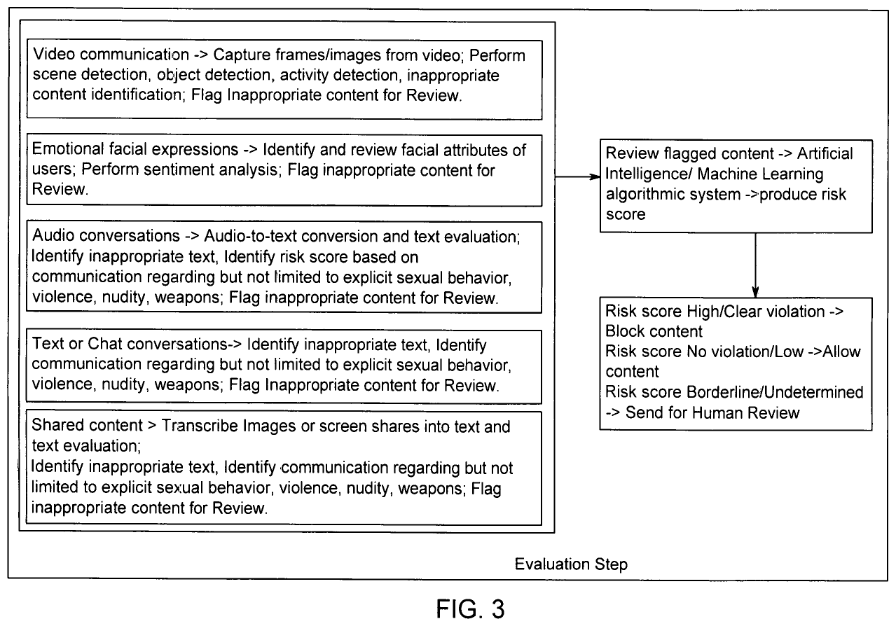

The evaluation step may include an identification process through which to identify unsafe or inappropriate content in various forms, including emotional facial expressions, text or chat conversations, audio conversations, and shared content, as shown in FIG. 3.

In some embodiments, the identification process may use classification or categorization to check, rank, and score content.

For emotional facial expressions, for example, when users are engaged in communication, the evaluation step may identify and review various facial attributes of users. For every user, emotion may be identified during the communication session, such as fear, happiness, sadness, anger, surprise, disgust, calmness, confusion, and smiling.

In some embodiments, the sentiment analysis may be performed among the users engaged in the communication. Sentiment detection could trigger a scoring process. Such a score by which users engaged in a communication may be optionally prompted for continuing to engage in communication or leave the communication or pause the communication. For example, the evaluation step may run through rules to check if one or more users are deemed to be angry and other users are deemed to have the emotion of being “sad” or having “fear” or “Disgusted” while at the same time, such communication are also deemed to be flagged for review by the system and users could communication are also deemed to be flagged for review by the system and users could be prompted with an optional button to continue engaging in the communication.

For video based communication between users, the frames or images in the video may be captured and evaluation engine checks for unsafe content such as but not limited to Explicit Nudity (such as Nudity, Graphic Male/Female Nudity, Sexual Activity, Illustrated Nudity, Adult Toys), Suggestive(such as Male/Female Swimwear/underwear, Partial Nudity, Revealing Clothes), Violence (such as Graphic, Physical, Weapon, Gore, Weapons, Self-Injury), Visually Disturbing (such as Emaciated Bodies, Corpses, Hanging). Image content evaluation may also be performed for images or visuals transmitted across the electronic communication may be evaluated.

For text or chat conversations, communication may be evaluated for unsafe content, such as inappropriate text including explicit sexual behavior, violence, nudity, weapons, danger, drugs, and gore.

In some embodiments, the evaluation step may check and rank text by classifying words; if the system deems text unsafe for transmission to the user, filtering system may block the text and/or optionally replace it with error blocking messages so that the users engaged in the conversation know that text was blocked.

For audio conversations, the evaluation step may convert audio conversations into text using existing audio-to-text algorithms, then evaluate the transcribed text in the same way as for text or chat communications (text evaluation). The filtering system may support communication in multiple languages and such communication may be translated to a language that the system can process prior to running the evaluation step.

For shared content such as text, video, images, and screenshares, the evaluation step may transcribe images or screenshares into text or images and evaluate that text using text evaluation or image content evaluation methods described above.

If shared content includes video content, the shared content can be evaluated through video evaluation (which can include a video/image evaluation process mentioned above).

In some embodiments, the evaluation step may provide a flagging mechanism based on the risk score of the content produce by the evaluation step so that some content may be flagged for review by a review mechanism (which may be governed by user- implemented rules or a categorization or classification process) that can be included in the filtering system of the present invention. In some embodiments, when content is flagged, users may be presented with a prompt to continue engaging in the communication and/or report some communication to the review mechanism. In some embodiments, the review mechanism may include artificial intelligence and/or combination of human decision-making processes. The users may be presented with a prompt to get consent to continue and engage in the conversation and/or to report the conversation.

Decision Step

The decision step may include steps with which to make decisions based on the information resulting from the evaluation step.

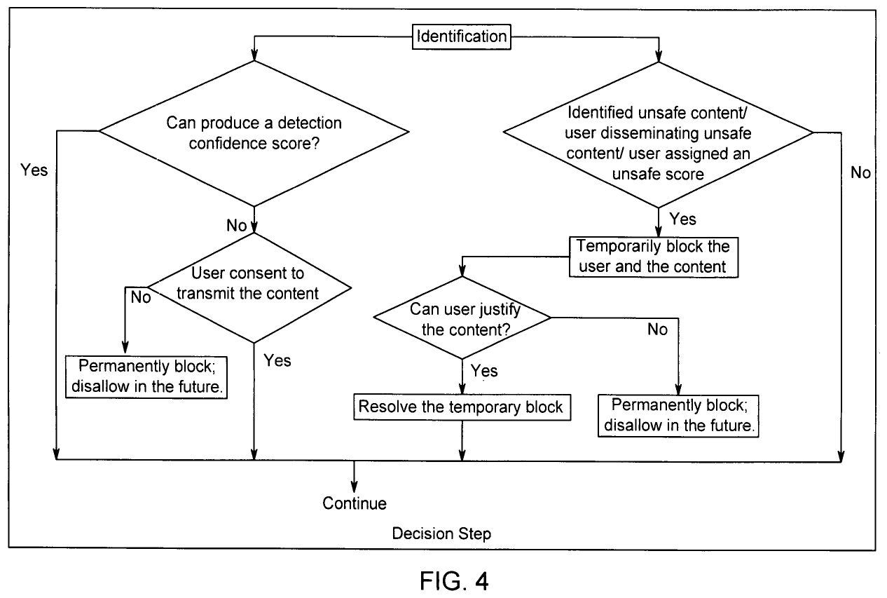

After evaluation of content, the decision step may follow various conditional processes, as shown in FIG. 4. If the system can be unable to produce a detection confidence score, an optional prompt may be presented to the user to obtain his or her consent to the presentation of that content to the user receiving the communication. The prompt may also allow users to report content as unsafe.

If content can be determined to be unsafe according to user-implemented rules or a categorization or classification process, such unsafe content may be blocked from communication between users, whether by filtering text, blurring video, moderating visuals or blocking audio deemed inappropriate.

A user who is disseminating unsafe content may be temporarily blocked.

A user who may be assigned an unsafe risk score, which may be determined by the category of content involved, may be given a chance to justify the content and resolve the temporary block. If users may not be able to justify within a given time frame, the block may become a permanent block.

If a user may be deemed to be unsafe, as can be determined by the category of content involved, that user may be banned and blocked from the communication temporarily or permanently, with a possibility of being disallowed from using the communication platform in future. Optionally, this banning and related information and blocking information may be recorded on a blockchain.

In some embodiments, a human review process may be introduced in the decision step alongside the artificial intelligence review of communication events prior to temporarily or permanently blocking an offending user or approving a user registration. A blockchain may be used to maintain a history of the safety of a user's engagements, which may be used to generate a rating system.

In some other embodiments, at the time of registration, user registration information such as the user image captured by the filtering system may be reviewed against the existing database or blockchain to compare the new registration against a database of unsafe users (who may have violated the rules and been permanently blocked) using techniques such as, but not limited to, facial or image recognition and/or artificial intelligence, and identify those who may not be allowed to re-register.

The steps and the processes described in connection with the embodiments disclosed herein can be embodied directly in hardware, in a software module executed by a processor, or in a combination of the two. A software module can reside in a memory unit that can include volatile memory, non-volatile memory, and network devices, or other data storage devices now known or later developed for storing information/ data. The volatile memory may be any type of volatile memory including, but not limited to, static or dynamic, random access memory (SRAM or DRAM). The non-volatile memory may be any non-volatile memory including, but not limited to, ROM, EPROM, EEPROM, flash memory, and magnetically or optically readable memory or memory devices such as compact discs (CDs) or digital video discs (DVDs), magnetic tape, and hard drives.

The computing device may be a desktop/laptop computer, a cellular phone, a personal digital assistant (PDA), a tablet computer, and other mobile devices of the type. Communications between components and/or devices in the systems and methods disclosed herein may be unidirectional or bidirectional electronic communication through a wired or wireless configuration or network. For example, one component or device may be wired or networked wirelessly directly or indirectly, through a third-party intermediary, over the Internet, or otherwise with another component or device to enable communication between the components or devices. Examples of wireless communications include, but are not limited to, radio frequency (RF), infrared, Bluetooth, wireless local area network (WLAN) (such as WiFi), or wireless network radio, such as a radio capable of communication with a wireless communication network such as a Long Term Evolution (LTE) network, WiMAX network, 3G network, 4G network, and other communication networks of the type. In example embodiments, network can be configured to provide and employ 5G wireless networking features and functionalities.

Although the invention has been explained in relation to its preferred embodiment, it is to be understood that many other possible modifications and variations can be made without departing from the spirit and scope of the invention.

What is claimed is:

1. A method of filtering content an electronic communication comprising:
evaluating the content, transmitted during the electronic communication wherein evaluating includes;
computing risk score associated with the content;
filtering out the content if the risk score crosses a threshold; and
making decision based on the risk score.

2. The method of claim 1 wherein evaluating further comprising flagging the content for review based on the risk score.

3. The method of claim 1 wherein decision includes blocking content from communication, based on the risk score.

4. The method of claim 1 wherein decision includes blocking sender disseminating content that crosses the risk score wherein the sender is the registered user and registration information is stored in a blockchain.

5. The method of claim 1 wherein content includes facial expressions, sentiment, emotions, text conversation, chat conversations, audio conversations, video communications or shared content.

6. The method of claim 4 further comprising capturing frames in the video communications to compute the risk score.

7. The method of claim 1 wherein the evaluating includes Artificial Intelligence/Machine Learning (AI/ML) algorithm to improve the evaluation.

8. The method of claim 1 wherein the filtering includes artificial intelligence/machine learning (AI/ML) algorithm to improve the filtering.

9. The method of claim 1 wherein evaluating includes computing the risk score for the content before transmitting the content to a receiver wherein the receiver is a registered user and registration information is stored in a blockchain.

10. A system for filtering content during electronic communication comprising:
a processor; and
a memory communicatively coupled to the processor, wherein the memory stores processor instructions, which, on execution, causes the processor to:
evaluate the content, transmitted during the electronic communication wherein evaluating includes;
computing risk score associated with the content;
filtering out the content if the risk score crosses a threshold; and
making decision based on the risk score.

11. The system of claim 10, wherein evaluate further comprising flagging the content for review based on the risk score.

12. The system of claim 10 wherein decision includes blocking content from communication, based on the risk score; and

13. The system of claim 10 wherein decision includes blocking sender disseminating content that crosses the risk score wherein the sender is the registered user and registration's information stored in a blockchain.

14. The system of claim 10 wherein content includes facial expressions, sentiment, emotions, text conversation, chat conversations, audio conversations, video communications or shared content.

15. The system of claim 14 further comprising capturing frames in the video communications to compute the risk score.

16. The system of claim 10 wherein the evaluating includes Artificial Intelligence/Machine Learning (AI/ML) algorithm to continuously improve the evaluation.

17. The system of claim 10 wherein the filtering includes artificial intelligence/machine learning (AI/ML) algorithm to continuously improve the filtering.

18. The system of claim 10 wherein evaluating includes computing the risk score for the content before transmitting the content to receiver wherein the receiver is registered user and registration's information stored in a blockchain

19. The system of claim 10 wherein the system can be deployed on sender's device, on receiver device, on servers or on cloud.
